(19) United States
(12) Patent Application Publication
(10) Pub. No.: US 2015/0159938 A1
(43) Pub. Date: Jun. 11, 2015

(54) COOLER WITH SOUND SYSTEM AND CHARGER

(71) Applicant: Greg Lewis Weckerly, Noblesville, IN (US)

(72) Inventor: Greg Lewis Weckerly, Noblesville, IN (US)

(21) Appl. No.: 14/099,904

(22) Filed: Dec. 6, 2013

(51) Int. Cl. F25D 23/12; H04R 1/02

(52) U.S. Cl. CPC F25D 23/12; H04R 1/028; F25D 2400/36

(57) ABSTRACT

A portable sound system produces high quality, water proof sound on a single charge for about 20 hours at full volume or for about 60 hours at ambient volume levels. The portable sound system also includes a cooler portion having the ability to cool about 50 or more cans of one's favorite beverage. The sound system cooler provides superior battery life with compact componentry and allows a user to use a multitude of music source options. The sound system cooler also includes one or more power ports for charging mobile electronic devices, even while being used as a sound system and cooler.

### BACKGROUND OF THE INVENTION

The present invention relates to coolers and, more particularly, to a cooler having a sound system and charger.

High quality mobile sound is often tied to one's automobile or other electrical source, make it nearly impossible to enjoy in more remote settings. Many conventional sound systems have a short battery life, or are bulky and cumbersome.

Other conventional sound systems do not cool drinks while providing high quality sound.

As can be seen, there is a need for a cooler that can not only keep beverages cool, but also provide a portable, high quality sound system with external power ports for charging external devices.

### SUMMARY OF THE INVENTION

In one aspect of the present invention, a cooler sound system comprises a cooler body; a cooler region formed in a portion of the cooler body; a rear lid covering the cooler region; a dry storage compartment; an electronics compartment; a front lid covering the dry storage compartment and the electronics compartment; at least two wheels disposed on opposite sides of a rear of the cooler body; a retractable handle extending from the rear of the cooler body; speakers in a front portion of the cooler body; at least one battery; at least one sound source input disposed in the electronics compartment; an amplifier configured to receive a sound signal from a device connected to the at least one sound source; and a control panel disposed in the electronics compartment.

These and other features, aspects and advantages of the present invention will become better understood with reference to the following drawings, description and claims.

### BRIEF DESCRIPTION OF THE DRAWINGS

FIG. 1 is a front perspective view of a cooler having a sound system and charger, according to an exemplary embodiment of the present invention;

FIG. 2 is a rear perspective view of the cooler of FIG. 1;

FIG. 3 is a front perspective view of the cooler of FIG. 1, illustrated with the front lid and rear lids in an open position;

FIG. 4 is a cross-sectional view taken along line 2-2 of FIG. 1; and

FIG. 5 is a perspective view showing various accessories usable with the cooler of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a portable sound system that produces high quality, water proof sound on a single charge for about 20 hours at full volume or for about 60 hours at ambient volume levels. The portable sound system also includes a cooler portion having the ability to cool about 50 or more cans of one's favorite beverage. Larger models can be designed with a capacity to hold up to ¼ barrel (pony keg). The sound system cooler provides superior battery life with compact componentry and allows a user to use a multitude of music source options. The sound system cooler also includes one or more power ports for charging mobile electronic devices, even while being used as a sound system and cooler.

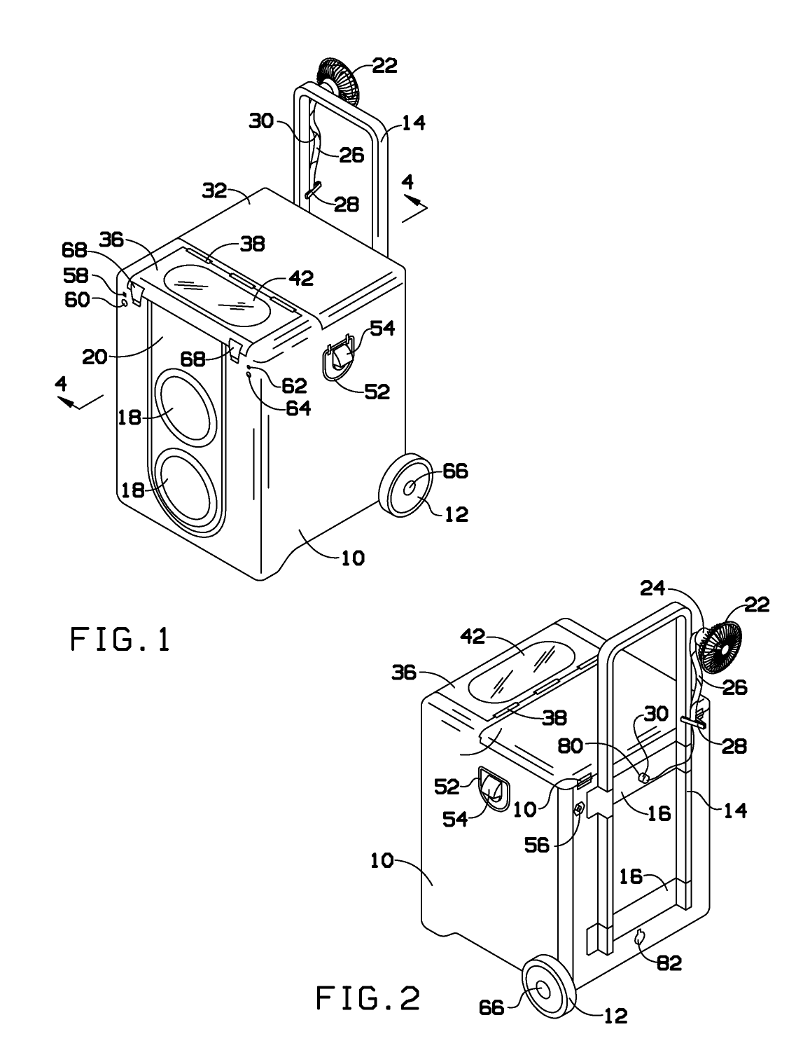

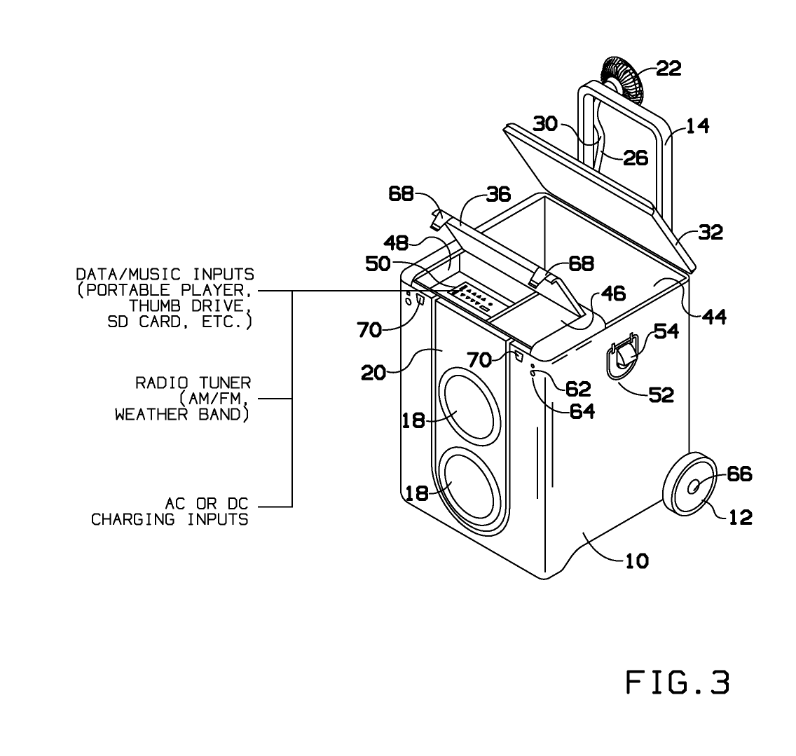

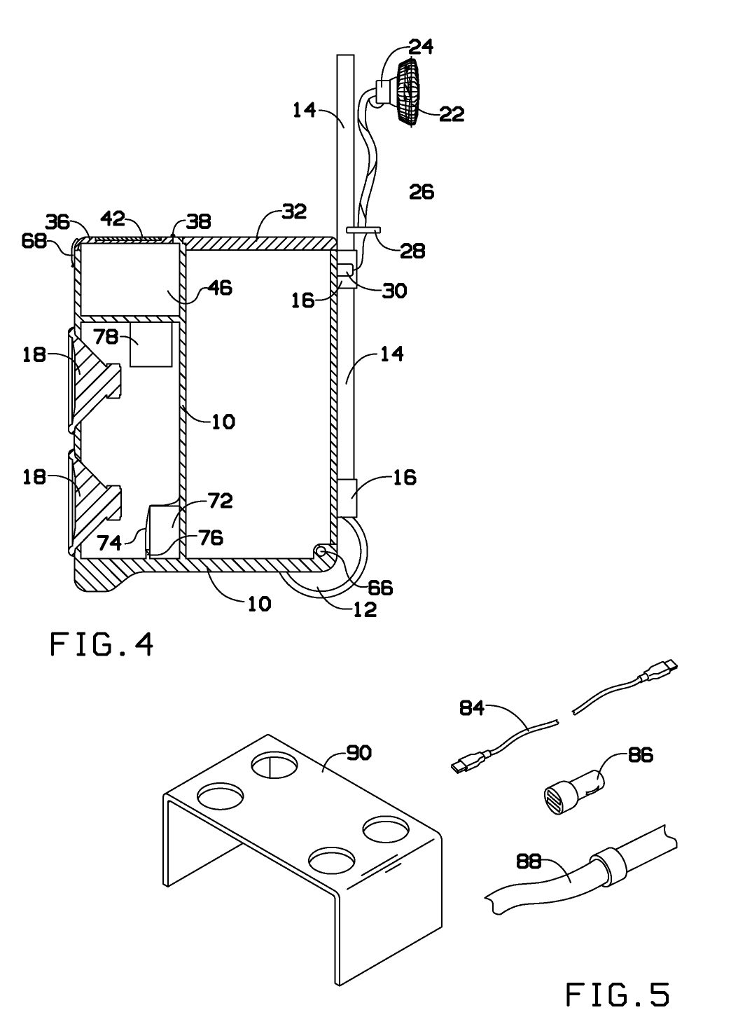

Referring now to FIGS. 1 through 4, a cooler body 10 can include at least two wheels 12 disposed on opposite sides of a back side thereof. An axle 66 can interconnect the wheels 12 and provide an axis for rotation thereabout. Of course, the wheels 12 can be connected by various means to the cooler body 10, provided that they are able to rotate to assist in movement of the cooler sound system.

A retractable handle 14 can be extended from the back side of the cooler body 10. A user can use the handle 14 to tilt the cooler body 10 onto the wheels 12 for ease of movement.

Speakers 18 can be disposed along a front side of the cooler body or on other sides of cooler body 10 depending on the model. The speakers 18 can be surrounded by a speaker panel 20, for example. The speaker panel 20 can be designed as a slide-in/slide-out plate to allow for easy access to the speakers and for easy upgrade if desired.

Behind the speakers 18 may be a chamber for containing one or more batteries 72. The batteries 72 may be retained by a battery retaining lip 76 and a battery strap 74, for example. Additionally, behind the speakers 18 may be housed an amplifier 78. The batteries 72 can be, for example, a 6-pound AMG dry cell sealed battery. The batteries 72 can be charged via, for example, a wall to USB dual stage 12 volt charger, where a larger charge, such as a 3-5 ampere charge, can be provided to rapidly charge the battery, and a lower, maintenance charge can be provided to maintain the battery at a desired level.

In some embodiments, a mister/fan 22 can be provided with the cooler sound system. The mister/fan 22 can include a water pump 24 which may be a powered or manual water pump. The mister/fan 22 can be mounted on a mister/fan shaft 26 and may be retained by a mister/fan clip 28. A mister/fan power supply 30 can provide appropriate power to the mister/fan 22. In some embodiments, the mister/fan 22 may connect directly to the batteries 72. In some embodiments, the mister/fan shaft 26 may be a flexible shaft to allow a user to position the mister/fan 22 in a desired direction.

A rear lid 32 can be provided to cover a cooler region 44 of the cooler sound system. The rear lid 32 may, for example, open on rear lid hinges 34. In some embodiments, the rear lid hinges 34 may be operable to hold the rear lid 32 open when fully opened and help keep the rear lid 32 closed when the rear lid 32 is closed.

A front lid 36 can provide access to a dry storage compartment 46 and an electronics compartment 48. The dry storage compartment 46 can provide a safe location to store portable electronic devices, such as mobile phones. The front lid 36 may, for example, open on front lid hinges 38. In some embodiments, the front lid hinges 38 may be operable to hold the front lid 36 open when fully opened and help keep the front lid 36 closed when the front lid 36 is closed. In some embodiments, a locking mechanism can be provided on the front lid 36 to keep items stored therein safe. Latches 68 can be provided on the front lid 36 to secure the front lid 36 in a closed position when engaged with later retainers 70 on the cooler body 10.

The front lid 36 may include an acrylic panel 42, such as a Plexi-glass panel, to allow a user to see therein. in some embodiments, lights may be disposed about the acrylic panel 42 for a desired effect.

A control panel 50 can be provided within the electronics compartment 48. The control panel 50 can include data/music inputs, such as inputs for portable music players, for USB storage devices, storage cards (such as SD cards, for example), and the like. The control panel 50 can also include a radio tuner that may include, for example, AM, FM and weather bands. Moreover, the control panel may also include AC or DC charging inputs, designed to charge the battery as needed.

A tether ring 52 can be provided on opposite sides of the cooler body 10. The tether rings 52 may provide a handle for assisting in moving the cooler sound system. A bottle opener 54 can be disposed on the cooler body 10, for example, as shown in the Figures, within the tether ring 52.

Various electronic features can be incorporated into the cooler sound system of the present invention. For example, a projector 56 can be provided in the cooler body 10. Additionally, a wireless remote receiver 58 can be provided to allow control of the sound system through the use of a remote control (not shown). A video camera 60 can also be provided, where a user can turn on the video camera 60 to capture video and/or pictures on internal or removable storage. In some embodiments, the video camera 60 can pass the image through to the projector 56.

The cooler sound system can include a wireless transmitter/receiver 62 which can operate via various protocols, such as Bluetooth, Wi-Fi, or the like. An infrared receiver 64 can be provided to allow various inputs and control to the cooler sound system. Various other sound inputs can be provided, such as phono jacks, RCA plugs and the like. These may be located in the electronics compartment 48 or may be disposed on a side or back or the cooler body 10.

Referring to FIG. 5, various accessories can be used with the cooler sound system of the present invention. For example, a wine bottle insert 90 can fit into the cooler region 44 to secure bottles, such as wind bottles. Various cords and adaptors can also be included with the cooler sound system, such as USB cables 84, 12V DC to USB adaptors 86, and the like. A water line and adaptor 88 can be provided to deliver water to the mister/fan 22. In some embodiments, the mister/fan 22 can be provided with water from melted ice from within the cooler region 44.

It should be understood, of course, that the foregoing relates to exemplary embodiments of the invention and that modifications may be made without departing from the spirit and scope of the invention as set forth in the following claims.

What is claimed is:

1. A cooler sound system comprising:
a cooler body;
a cooler region formed in a portion of the cooler body;
a rear lid covering the cooler region;
a dry storage compartment;
an electronics compartment;
a front lid covering the dry storage compartment and the electronics compartment;
at least two wheels disposed on opposite sides of a rear of the cooler body;
a retractable handle extending from the rear of the cooler body;
speakers in a front portion of the cooler body;
at least one battery;
at least one sound source input disposed in the electronics compartment;
an amplifier configured to receive a sound signal from a device connected to the at least one sound source; and
a control panel disposed in the electronics compartment.

2. The cooler of claim 1, further comprising a mister/fan attached to the cooler body and powered by the at least one battery.

3. The cooler of claim 2, wherein the mister/fan receives water via a pump from water in the cooler region.

4. The cooler of claim 1, further comprising a video camera configured to receive a video signal from outside of the cooler body.

5. The cooler of claim 1, further comprising a projector configured to project an image or a video outside of the cooler body.

6. The cooler of claim 1, further comprising at least one signal receiver operable to receive a signal from outside of the cooler body.

7. The cooler of claim 6, wherein the signal is a remote control signal.

8. The cooler of claim 1, further comprising a bottle insert configured to fit inside the cooler region and operable to retain a plurality of bottles therein.

9. The cooler of claim 1, further comprising tether rings disposed on at least sides of the cooler body.

10. The cooler of claim 1, further comprising at least one bottle opener disposed on at least one side of the cooler body.
